(19) United States
(12) Patent Application Publication
(10) Pub. No.: US 2013/0167812 A1
(43) Pub. Date: Jul. 4, 2013

(54) EXHAUST GAS RECIRCULATION VALVE

(71) Applicants: Akihiro Kurihara, Tokyo (JP); Satoru Hasegawa, Tokyo (JP)

(72) Inventors: Akihiro Kurihara, Tokyo (JP); Satoru Hasegawa, Tokyo (JP)

(73) Assignee: MITSUBISHI ELECTRIC CORPORATION, Tokyo (JP)

(21) Appl. No.: 13/819,754

(22) PCT Filed: Dec. 13, 2010
(86) PCT No.: PCT/JP2010/007221

§ 371 Date: Feb. 28, 2013

(51) Int. Cl. F02M 25/07

(52) U.S. Cl. CPC F02M 25/0793
USPC 123/568.11

(57) ABSTRACT

An exhaust gas recirculation valve includes an exhaust passage having an exhaust gas inlet and an exhaust gas outlet aligned on the same line, an EGR passage branched from the exhaust passage, a shaft attached rotatably at a branching point between the exhaust passage and the EGR passage, and an elliptically shaped butterfly valve rotating integrally with the shaft to open/close the exhaust passage and the EGR passage.

### TECHNICAL FIELD

The present invention relates to an exhaust gas recirculation valve for recirculating exhaust gas to an inlet system.

### BACKGROUND ART

An exhaust gas recirculation (EGR) valve controls the opening of a valve body arranged at a branching point between an exhaust passage and an exhaust gas recirculation passage to thereby regulate the amount of recirculated exhaust gas that is recirculated to an intake passage via the exhaust gas recirculation passage.

For example, in a valve device of Patent Document 1, a butterfly valve is provided within a housing formed at a section where an inlet tube into which exhaust gas flows from an internal combustion engine, a first outlet tube leading to the outside, and a second outlet tube leading to a recirculation device intersect one another. The butterfly valve is located downstream of the connecting portion of those tubes at a position to hinder the flow of the fluid thereto, and has a three-way valve structure configured to control the flow of the fluid by being rotated with a motor and to control the amount of exhaust gas flowing to the recirculation device.

For other examples of the three-way valve structure, there are Patent Documents 2 and 3, for instance. An exhaust gas processing device of Patent Document 2 is constructed of, within a valve chamber having one inlet and two outlets, an arm turning about a spindle as a fulcrum, a support rod provided at a valve guard of this arm, and flap valves supported on the opposite sides of the arm with the support rod to have a degree of freedom in inclination, and has a three-way valve structure configured to alternately collect contaminants in the exhaust gas by alternately opening/closing the two outlets with the front and back surfaces of the flap valve.

Also, an exhaust gas recirculation device of Patent Document 3 has a butterfly valve provided at a merging portion between a cooler passage and a bypass passage extending in parallel, and has a three-way valve structure for controlling a mixing ratio of exhaust gases flowing into the merging portion from the passages.

### PRIOR ART DOCUMENTS

### Patent Documents

Patent Document 1: Japanese Translation of PCT Application No. 2009-517595
Patent Document 2: Japanese Patent Application Publication No. H10-121996
Patent Document 3: Japanese Patent Application Publication No. 2009-156115

### SUMMARY OF THE INVENTION

### Problems to be Solved by the Invention

In the three-way valve structure of Patent Document 1, the butterfly valve is located at the position to hinder the flow of the exhaust gas, which poses a problem leading to losses of the flow rate and pressure. In addition, since the inlet and outlet tubes for the exhaust gas are not aligned on a straight line, an exhaust gas pipe connected to the outlet tube has to be bent to draw back to the position of a muffler, which may pose problems such as increased size of the housing, and decreased degree of freedom in piping in an engine layout.

The three-way valve structures of Patent Document 2 and 3 have no configurations to be intended for exhaust gas recirculation valves, they cannot be simply applied to the recirculation ones. In addition, like Patent Document 1, the valve is located at the position to hinder the flow of the fluid, and the inlet and outlets are not arranged linearly, which may also cause the aforementioned problem.

The present invention is made to solve the above-described problems, and an object of the invention is to provide an exhaust gas recirculation valve in which an exhaust passage is formed linearly to reduce the loss of a flow rate thereof, and in which, for example, no occurrence of bends of an exhaust pipe due to an arrangement of the exhaust gas recirculation valve is implemented to thus improve a degree of freedom in piping in an engine layout.

### Means for Solving the Problems

An exhaust gas recirculation valve according to the present invention includes: a linear exhaust passage for passing exhaust gas therethrough; an exhaust gas recirculation passage, branched from the exhaust passage, for conducting the exhaust gas to an intake passage; a shaft rotatably located on an inner wall of a passage that is branched to the exhaust passage and the exhaust gas recirculation passage; and a butterfly valve having two wings rotating about the shaft, and configured such that when a first wing thereof opens the exhaust passage, a second wing thereof closes the exhaust gas recirculation passage, and that when the first wing narrows the exhaust passage, the second wing opens the exhaust gas recirculation passage.

### Effect of the Invention

According to the invention, when the exhaust passage is formed linearly, the pressure loss of the exhaust gas can be suppressed to thereby reduce the loss of the flow rate, and also, for example, no occurrence of bends of an exhaust gas pipe due to an arrangement of the exhaust gas recirculation valve is implemented to thus improve a degree of freedom in piping in an engine layout, which may achieve compactness thereof.

### BRIEF DESCRIPTION OF THE DRAWINGS

FIG. 1 is an appearance perspective view of an exhaust gas recirculation valve according to Embodiment 1 in the present invention, showing a state in which an exhaust passage is opened, and an EGR passage the valve is closed.

FIG. 2 is an appearance perspective view of the exhaust gas recirculation valve according to Embodiment 1, showing a state in which the exhaust passage is closed, and the EGR passage is opened.

FIG. 3 is a diagram showing a configuration example of an engine mechanism to which the exhaust gas recirculation valve according to Embodiment 1 is applied.

FIG. 4 is a cross-sectional view of the exhaust gas recirculation valve taken along a line A-A shown in FIG. 1, showing a state in which the exhaust passage is opened, and the EGR passage is closed.

FIG. 5 is a cross-sectional view of the of the exhaust gas recirculation valve taken along the line A-A shown in FIG. 1, showing a state in which the exhaust passage is closed, and the EGR passage is opened.

FIG. 6 shows cross-sectional views of configuration examples of the exhaust passage: FIG. 6(a) shows the one with an inclination of 0 degrees; FIG. 6(b) shows the one with an inclination of 45 degrees; and FIG. 6(c) shows the one with an inclination of 90 degrees.

FIG. 7 shows CFD analysis results indicating the relationships between the angles of inclination of the exhaust passage and the flow rates within the exhaust passage.

FIG. 8 is a front view showing an elliptical shape of a butterfly valve according to Embodiment 1.

FIG. 9 is an appearance perspective view of an exhaust gas recirculation valve having a housing shape in correspondence with a butterfly valve having a complete round shape.

FIG. 10 is a front view showing a modification of the butterfly valve according to Embodiment 1.

FIG. 11 is a cross-sectional view showing an exhaust gas recirculation valve having an asymmetrically shaped butterfly valve shown in FIG. 10.

### BEST MODE FOR CARRYING OUT THE INVENTION

In the following, in order to describe the present invention in more detail, embodiments for carrying out the invention will now be described in detail with reference to the accompanying drawings.

### Embodiment 1

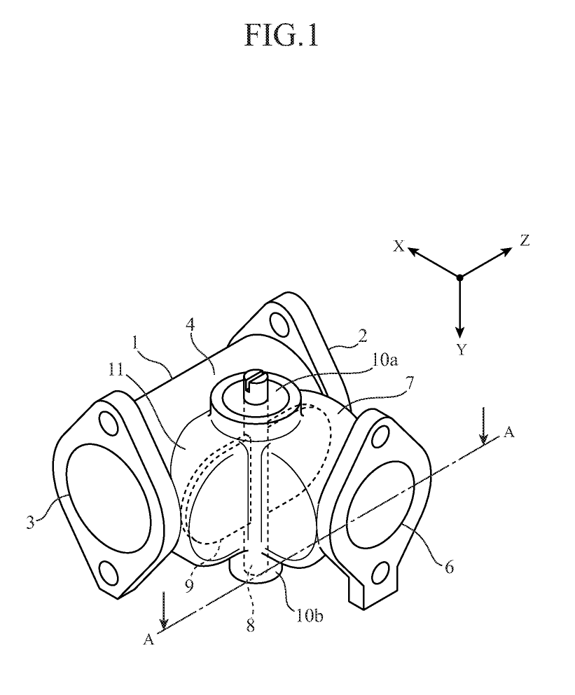

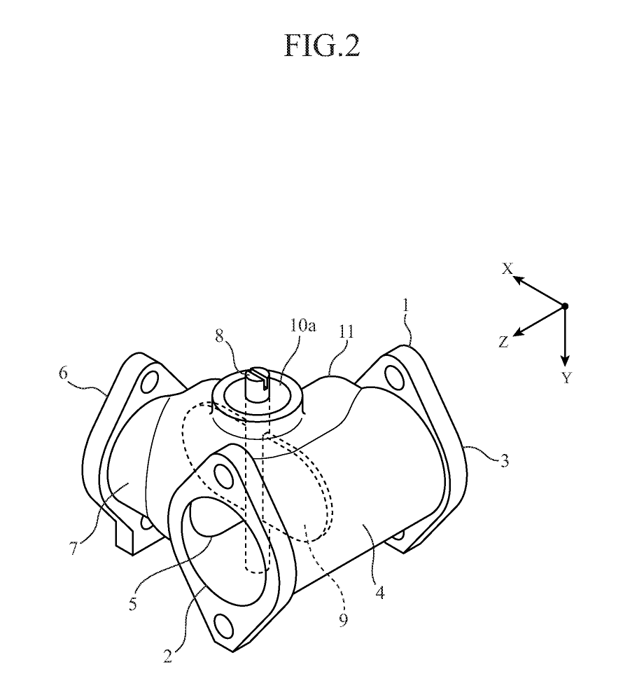

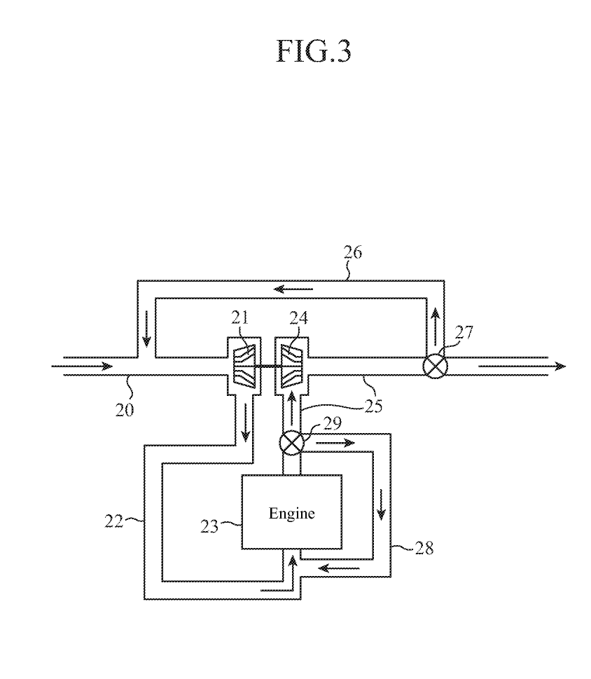

As shown in FIGS. 1 and 2, an exhaust gas recirculation valve according to Embodiment 1 has a three-way valve structure in which a butterfly-shaped valve (hereinafter, referred to as ‘butterfly valve’) 9 is provided inside a housing 1 having an exhaust gas inlet 2 as an entrance of fluid, and an exhaust gas outlet 3 and an EGR gas outlet 6 as exits thereof, and switches the flow direction of the fluid introduced through the exhaust gas inlet 2 to the direction toward the exhaust gas outlet 3 or the EGR gas outlet 6. In the following, a description will be given by using an example where the exhaust gas recirculation valve is applied to an exhaust gas recirculation valve 27 or an exhaust gas recirculation valve 29 in an engine mechanism shown in FIG. 3.

In FIG. 3, air flowing through an intake passage 20 is compressed by a compressor 21, and this compressed air is supplied to an engine combustion chamber 23 by way of an intake passage 22. The exhaust gas discharged from the engine combustion chamber 23 passes through the exhaust passage 25 while driving a turbine 24, and is discharged to the outside. A low-pressure EGR passage 26 is formed to recirculate the low-pressure exhaust gas flowing through the exhaust passage 25 downstream of the turbine 24 to an intake passage 20 upstream of the compressor 21; the exhaust gas recirculation valve 27 is installed to control the flow rate of the exhaust gas recirculated from the exhaust passage 25 to the low-pressure EGR passage 26. Alternatively, a high-pressure EGR passage 28 is formed to recirculate the high-pressure exhaust gas flowing through the exhaust passage 25 upstream of the turbine 24, that is, downstream of the engine combustion chamber 23 to the intake passage 22 upstream of the engine combustion chamber 23, and an exhaust gas recirculation valve 29 is installed to control the flow rate of the exhaust gas recirculated from the exhaust passage 25 to the high-pressure EGR passage 28.

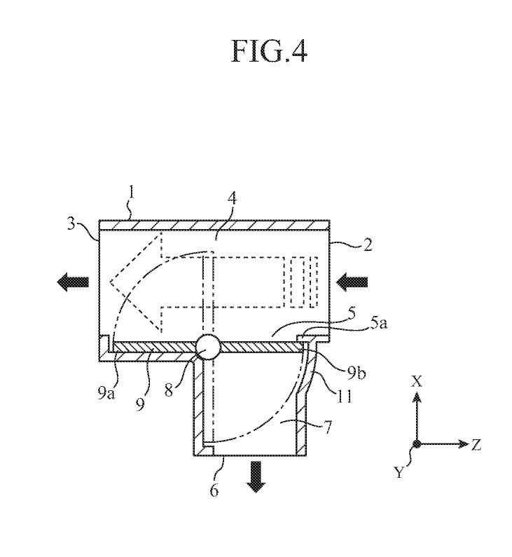

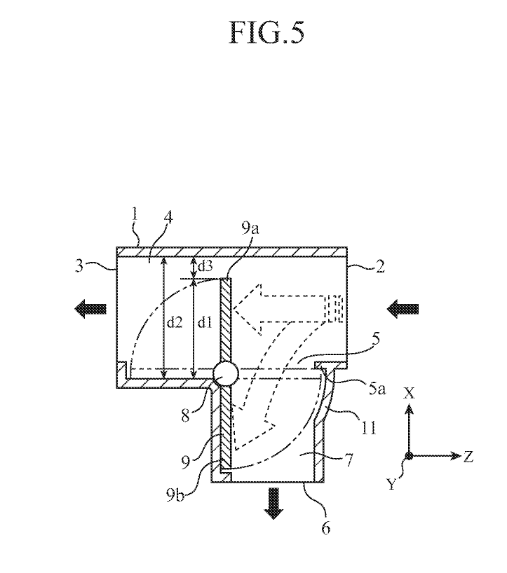

FIGS. 4 and 5 are cross-sectional views of the exhaust gas recirculation valve taken along a line A-A shown in FIG. 1. It is noted that FIGS. 1 and 4 show a state in which the valve is opened on the exhaust passage 4 side, and the valve is closed on the EGR passage 7 side, and that FIGS. 2 and 5 show a state in which the valve is closed on the exhaust passage 4 side, and the valve is opened on the EGR passage 7 side.

In the exhaust gas recirculation valve shown in FIGS. 1, 2, 4 and 5, a linear exhaust passage 4 is formed in the housing 1 to communicate the exhaust gas inlet 2 with the exhaust gas outlet 3. This exhaust passage 4 communicates with the exhaust passage 25 shown in FIG. 3 to flow the exhaust gas from the exhaust gas inlet 2 toward the exhaust gas outlet 3. Also, an EGR passage 7 branched from the exhaust passage 4 is formed within the housing 1. The EGR passage 7 is branched in a direction substantially orthogonal to the linear direction of the exhaust passage 4. This EGR passage 7 communicates with the low-pressure EGR passage 26 (or the high-pressure EGR passage 28) to flow the gas to be recirculated from a branch opening 5 toward the EGR gas outlet 6 (hereinafter, referred to as ‘EGRgas’). The EGR gas emitted from the EGR gas outlet 6 passes through the low-pressure EGR passage 26 (or the high-pressure EGR passage 28) and is led to the intake passage 20 (or the intake passage 22).

Bearing sections 10a, 10b are formed at the branching point in the housing 1 where the EGR passage 7 and the exhaust passage 4 are branched. When these bearing sections 10a, 10b rotatably support a shaft 8 at its opposite ends in an axial direction thereof, the shaft 8 is pivotally supported at a certain position on the inner wall of the passages at the branching point. An elliptical butterfly valve 9 is attached to this shaft 8. A valve seat 5a to be seated by a second wing 9b of the butterfly valve 9 is formed in the remaining part of the opening of the branch opening 5 except the part where the shaft 8 is disposed.

Incidentally, although in the illustrated example, the shaft 8 is supported at the opposite ends by the bearing sections 10a, 10b, it may be cantilever supported by the bearing section provided at either of the ends.

When the shaft 8 is rotation driven by an actuator (not shown), the butterfly valve 9 attached to this shaft 8 is also rotated integrally. The rotation of the butterfly valve 9 in one direction causes a first wing 9a to gradually move in a direction to close the exhaust passage 4, narrowing an opening area thereof, and at the same time the second wing 9b gradually opens the EGR passage 7. When the butterfly valve 9 is rotated in the opposite direction thereof, the first wing 9a gradually opens the exhaust passage 4, and at the same time the second wing 9b gradually closes the EGR passage 7.

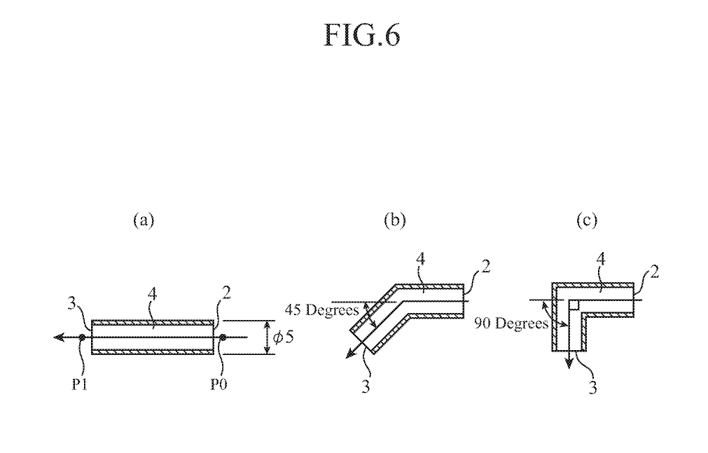

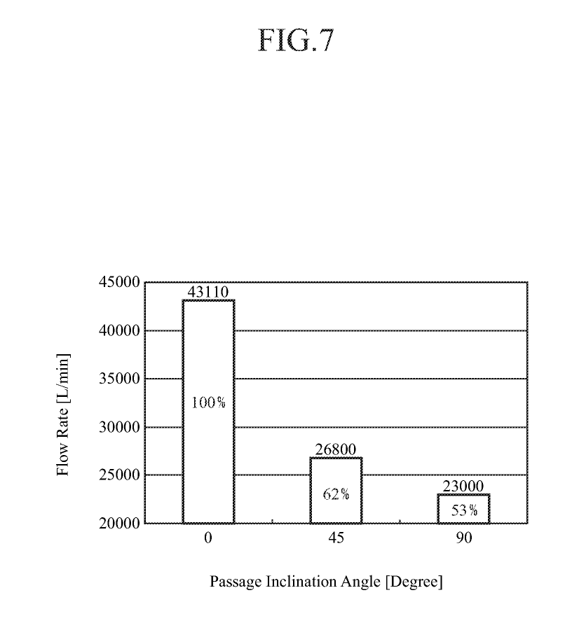

Hereupon, a description will be given of a relationship between shapes of the exhaust passage 4 and losses in flow rate and pressure. FIG. 6(a) is a cross-sectional view of an exhaust passage 4 with an inclination angle of 0 degrees in which an exhaust gas inlet 2 and an exhaust gas outlet 3 are aligned on a straight line in the same manner as the exhaust passage 4 in Embodiment 1; FIG. 6(b) is a cross-sectional view of an exhaust passage 4 inclined halfway at an angle of 45 degrees; and FIG. 6(c) is a cross-sectional view of an exhaust passage 4 inclined halfway at an angle of 90 degrees. FIG. 7 shows results of CFD (Computational Fluid Dynamics) analysis of the flow rate within the passage and the pressure loss within the passage when fluid is flown in directions of arrows through the exhaust passages 4 with the inclination angles shown in FIG. 6, respectively. It is assumed that the diameter (φ) of the exhaust passages 4 is 50 mm, and a differential pressure ΔP between points P0 and P1 is fixed at 10 kPa. Also, the vertical axis of the graph represents flow rates [L/min], while the horizontal axis represents inclination angles [degree] of the exhaust passages 4.

From the graphs in FIG. 7, when the flow rate in the exhaust passage 4 with an inclination angle of 0 degrees is defined as 100%, the flow rate of the exhaust passage 4 with an inclination angle of 45 degrees drops to about 62%, and the flow rate of the exhaust passage 4 with an inclination angle of 90 degrees drops to about 53%. In other words, the pressure loss within the passage is increased as the inclination angle becomes greater. As mentioned above, it can be seen that the fluid is easily affected by the shape of the passage, and that the linear passage exhibits the least losses in the flow rate and pressure.

Since the exhaust passage 4 is formed linearly in Embodiment 1, the losses in the flow rate and pressure of the exhaust gas are lowered. In addition, since the shaft 8 is arranged at the branching point between the exhaust passage 4 and the EGR passage 7, the shaft 8 does not interfere with the flow of the exhaust gas, which enables to suppress the loss in the flow rate. Meanwhile, when the exhaust passage 4 is opened, the first wing 9a of the butterfly valve 9 conforms to the inner wall surface of the exhaust passage 4, and at the same time the second wing 9b closes the branch opening 5, and therefore the two (first and second) wings 9a, 9b do not interfere with the flow of the exhaust gas within the exhaust passage 4, and the loss in the flow rate can be suppressed.

Further, since the exhaust gas inlet 2 and the exhaust gas outlet 3 are located on the same straight line, in the case where the exhaust gas recirculation valve is arranged midway of the exhaust passage 25 shown in FIG. 3, a degree of freedom in piping in an engine layout can be improved such that no bends of an exhaust pipe constituting the exhaust passage 25 are produced, resulting in leading to compactness of the engine.

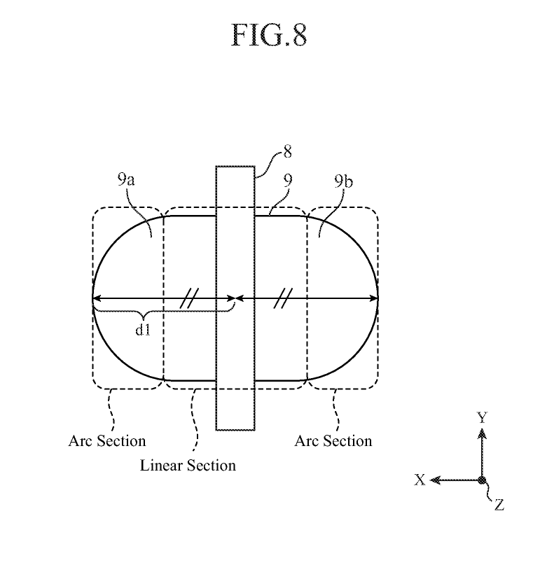

FIG. 8 is a front view showing a shape of the butterfly valve 9. The butterfly valve 9 has an elliptical shape formed of a linear section extending orthogonally to an axial direction of the shaft 8, and arc sections at the opposite ends thereof. A radius of curvature of these arc sections can be set arbitrarily.

In an example shown in FIG. 8, the shaft 8 is fixed at the center of a longitudinal direction of the butterfly valve 9, and the two wings 9a and 9b have a symmetrical configuration about the shaft 8. The wing 9a functions as a valve body to close the exhaust passage 4, and the wing 9b functions as a valve body to close the EGR passage 7. Since the butterfly valve 9 has a simple elliptical shape, it can be fabricated easily by punching a sheet material such as a sheet metal. The shaft 8 and the butterfly valve 9 can be fixed to each other by any fastening method such as pinning or screwing.

Also, since the butterfly valve 9 has an elliptical shape with the arc sections conforming to a circular cross section of the cylindrical exhaust passage 4, an extended diameter of a valve orbit passing portion 11 in the housing 1 that is a portion where the butterfly valve 9 passes during opening/closing operations thereof can be suppressed to a minimum. Thus, compactness and weight reduction of the housing 1 can be achieved.

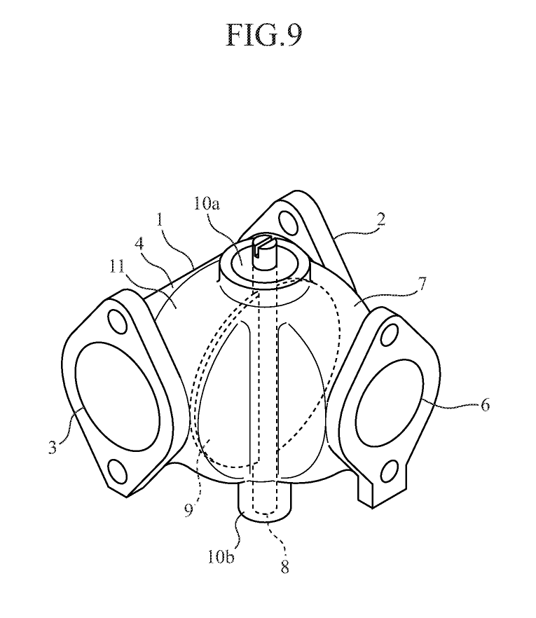

In contrast, FIG. 9 shows an exhaust gas recirculation valve in which the butterfly valve 9 has a complete round shape instead of the elliptical shape. When it is schemed that the butterfly valve 9 is formed in a shape having a complete round and conforming to the circular cross section of the exhaust passage 4, the butterfly valve 9 has to be extended in an axial direction of the shaft 8. This requires the diameter of the housing 1 to be also enlarged in order to ensure the valve orbit passing portion 11. For this reason, the housing 1 is increased in size and also in weight. Incidentally, as not illustrated in the drawings, also in the case where the butterfly valve 9 is formed in a rectangular shape, the diameter of the housing 1 has to be increased.

Furthermore, when the valve is opened at the exhaust passage 4 as shown in FIG. 4, the orientation of the two wings 9a and 9b aligns with the direction of the exhaust gas and therefore torque to be produced in the shaft 8 is small. Thus, the operations for easily opening and closing the valve become possible. In addition, since the produced torque is applied in a direction where the valve opens the exhaust passage 4, it serves as a fail-safe to help closing of the EGR passage 7.

On the other hand, when the valve is closed at the exhaust passage 4 as shown in FIG. 5, the butterfly valve 9 is subjected to the pressure of the exhaust gas to produce the torque on the shaft 8; however, since the two wings 9a and 9b are symmetrical about the shaft 8, the pressures applied to the wings are substantially equal to each other and the torque is reduced. Thus, the operations for opening and closing the valve become possible.

In the butterfly valve 9 described so far, it is configured that since as shown in FIG. 5 a length d1 from the shaft 8 to the tip of the wing 9a is made shorter than a diameter d2 of the exhaust passage 4, the valve is not closed completely but a clearance (amount of clearance d3) is left even when the valve is closed at the exhaust passage 4. This makes it possible to narrow the exhaust passage 4 concurrently with an intake of the EGR gas to thereby provide a function of a throttle valve at the same time.

Since the length d1 of the wing 9a can be adjusted easily by forming the butterfly valve 9 in an asymmetrical shape about the shaft 8, any amount of clearance d3, that is, the maximum EGR amount can be adjusted according to the conditions of an engine combustion chamber 23.

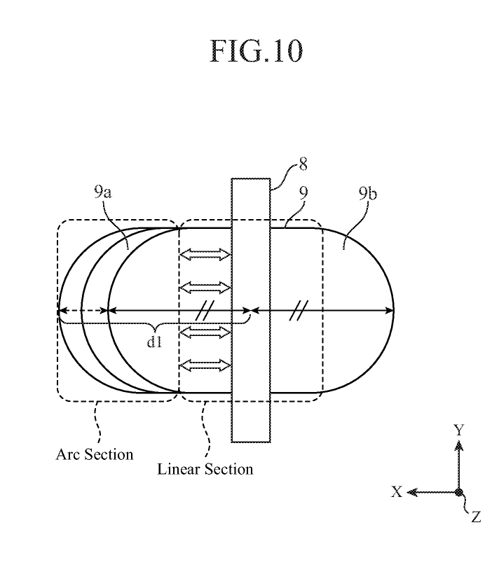

FIG. 10 is a front view showing a modification of the butterfly valve 9, and is formed in an asymmetrical shape with the length d1 changed as mentioned above. The asymmetrically shaped butterfly valve 9 can be fabricated by only changing the dimension of the linear section without any need of changing the shape of the arc sections. Accordingly, like the symmetrical butterfly valve 9 shown in FIG. 8, the corresponding valve can be formed in a simple elliptical shape, and can be fabricated easily by punching a sheet metal or the like.

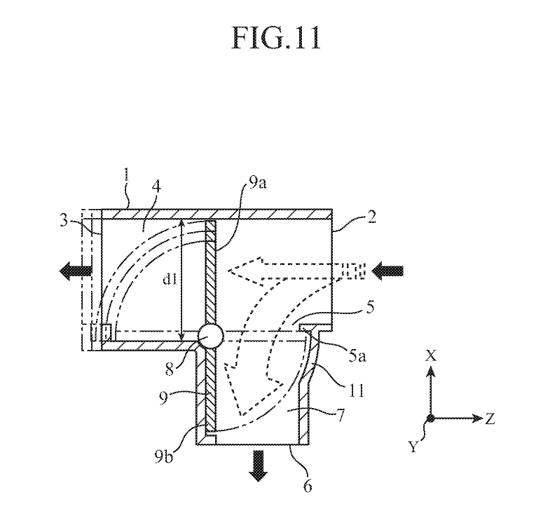

FIG. 11 is a cross-sectional view showing an exhaust gas recirculation valve having the asymmetrically shaped butterfly valve 9 illustrated in FIG. 10. The maximum. EGR amount of the EGR gas flowing into the EGR passage 7 becomes greater as the length d1 of the wing 9a which closes the exhaust passage 4 is increased to restrict the amount of the exhaust gas. In such a way, since the restricting amount of the flow of the exhaust gas can be adjusted by changing the shape of the butterfly valve 9, the housing 1 need not be transformed.

Further, when the valve is closed at the exhaust passage 4, the pressures applied to the two wings 9a and 9b are adjusted such that an area ratio between the wings 9a and 9b is changed; thus, an adjustment of the torque can be done easily. Therefore, it becomes possible to further reduce the torque produced in the butterfly valve 9.

As described above, according to Embodiment 1, the exhaust gas recirculation valve is configured to include: the linear exhaust passage 4 for causing the exhaust gas to pass therethrough; the EGR passage 7, branched from the exhaust passage 4, for conducting the exhaust gas to the intake passage 20 (or the intake passage 22); the rotatable shaft 8 rotatably located on the inner wall of the passage that is branched to the exhaust passage 4 and the EGR passage 7; and the butterfly valve 9 having the two wings 9a, 9b rotating about the shaft 8, and configured such that when the first wing 9a opens the exhaust passage 4, the second wing 9b closes the exhaust gas recirculation passage 7, and that when the first wing 9a narrows the exhaust passage 4, the second wing 9b opens the EGR passage 7. For this reason, the pressure loss of the exhaust gas flowing through the exhaust passage 4 is suppressed to thereby reduce the loss in the flow rate. In addition, the degree of freedom in piping in an engine layout can be improved by, for instance, no occurrence of bends of the exhaust pipe due to the arrangement of the exhaust gas recirculation valve, and consequently the engine can be made compact. Further, since the valve body is formed in a butterfly shape, the torque can be reduced.

Also, according to Embodiment 1, it is configured that the butterfly valve 9 has an elliptical shape including the linear section in a direction orthogonal to the axial direction of the shaft 8, and the arc sections at the opposite ends thereof, and therefore the enlargement of the diameter in the valve orbit passing portion 11 can be suppressed to a minimum to thereby perform the downsizing and weight reduction of the housing 1. Further, the valve can be simplified in the shape, and fabricated easily and at low cost.

Also, according to Embodiment 1, the butterfly valve 9 can be easily formed in an asymmetrical shape when the linear section in the elliptical shape of the butterfly valve 9 is only changed in the dimension. Then, it is configured that the butterfly valve 9 has the two wings 9a, 9b having an elliptical shape to be asymmetrical about the shaft 8 to form a clearance between the first wing 9a and the internal wall of the exhaust passage 4, when the first wing 9a closes the exhaust passage 4, and therefore the amount of throttling the exhaust in the exhaust passage 4 can be adjusted and the torque can be further reduced.

However, according to the present invention, within the scope of the invention, a modification of arbitrary components in the embodiments or an omission of arbitrary components in the embodiments is possible.

### INDUSTRIAL APPLICABILITY

As described above, the exhaust gas recirculation valve of the present invention may be used as the exhaust gas recirculation valve 27 for low-pressure EGR or as the exhaust gas recirculation valve 29 for high-pressure EGR as shown in FIG. 3. However, since the increased flow rate of the exhaust gas is achieved in such a manner that the exhaust passage is formed linearly and also that the shaft and the butterfly valve are arranged at positions not interfering with the flow of the exhaust gas, it is more suitable for use in the exhaust gas recirculation valve for low-pressure EGR.

### EXPLANATION OF REFERENCE NUMERALS

1 housing, 2 exhaust gas inlet, 3 exhaust gas outlet, 4 exhaust passage, 5 branch opening, 5a valve seat, 6 EGR gas outlet, 7 EGR passage, 8 shaft, 9 butterfly valve, 9a, 9b wing, 10a, 10b bearing section, 11 valve orbit passing portion, 20, 22 intake passage, 21 compressor, 23 engine combustion chamber, 24 turbine, 25 exhaust passage, 26 low-pressure EGR passage, 27, 29 exhaust gas recirculation valve, 28 high-pressure EGR passage

1. An exhaust gas recirculation valve comprising:
a linear exhaust passage for passing exhaust gas therethrough;
an exhaust gas recirculation passage, branched from said exhaust passage, for conducting said exhaust gas to an intake passage;
a shaft rotatably located on an inner wall of a passage that is branched to said exhaust passage and said exhaust gas recirculation passage; and
a butterfly valve having two wings rotating about said shaft, and configured such that when a first wing thereof opens said exhaust passage, a second wing thereof closes said exhaust gas recirculation passage, and that when said first wing narrows said exhaust passage, said second wing opens said exhaust gas recirculation passage,
wherein the valve arrangement position of the butterfly valve is provided at a corner of a three-way valve passage, and the butterfly valve has an elliptical shape including a linear section in a direction that is orthogonal to an axial direction of said shaft, and arc sections at the opposite ends thereof.

2. (canceled)

3. The exhaust gas recirculation valve according to claim 1, wherein the butterfly valve has the two wings having an elliptical shape to be asymmetrical about the shaft to form a clearance between the first wing and the internal wall of said exhaust passage, when the first wing closes said exhaust passage.
